(19) United States
(12) Patent Application Publication
(10) Pub. No.: US 2009/0074621 A1
(43) Pub. Date: Mar. 19, 2009

(54) STIRRER AND ANALYZER

(75) Inventor: Miyuki MURAKAMI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/209,777

(22) Filed: Sep. 12, 2008

Related U.S. Application Data
(63) Continuation of application No. PCT/JP2006/324078, filed on Dec. 1, 2006.

(30) Foreign Application Priority Data
Mar. 16, 2006 (JP) 2006-073002

(51) Int. Cl. G01N 21/75; B01F 11/02

(52) U.S. Cl. 422/82.05; 366/116

(57) ABSTRACT

A stirrer is for stirring a liquid held in a vessel by sound waves. The stirrer includes a sound wave generator that generates the sound waves to be applied to the liquid; and a controller that controls drive conditions for the sound wave generator in accordance with changes with time of flow arising in the liquid by the sound waves. An analyzer is for stirring and reacting different liquids to measure an optical property of a reaction liquid using the stirrer, and thus to analyze the reaction liquid.

### CROSS-REFERENCE TO RELATED APPLICATIONS

This application is a continuation of PCT international application Ser. No. PCT/JP2006/324078 filed Dec. 1, 2006 which designates the United States, incorporated herein by reference, and which claims the benefit of priority from Japanese Patent Application No. 2006-073002, filed Mar. 16, 2006, the entire contents of which are incorporated herein by reference.

### BACKGROUND OF THE INVENTION

1. Field of the Invention

The present invention relates to a stirrer and an analyzer.

2. Description of the Related Art

An analyzer equipped with a stirrer for stirring a liquid containing a specimen and a reagent held in a vessel by a sound wave generated by a sound wave generating device has been known (See, for example, Japanese Patent No. 3642713). An analyzer disclosed in Japanese Patent No. 3642713 controls an irradiation position and irradiation intensity of sound waves for each target to be analyzed to perform efficient stirring for each target to be analyzed.

When a liquid is stirred by irradiating the liquid with a sound wave generated by a sound wave generating unit, an acoustic flow that is generated in the liquid after a lapse of a certain time with irradiation of the sound wave will be a steady flow in which the flow at the same position is at the same flow rate. Thus, if a steady flow is generated in the liquid, a retention portion of flow is generated outside and inside of the steady flow.

### SUMMARY OF THE INVENTION

A stirrer according to one aspect of the present invention is for stirring a liquid held in a vessel by sound waves, and includes a sound wave generator that generates the sound waves to be applied to the liquid; and a controller that controls drive conditions for the sound wave generator in accordance with changes with time of flow arising in the liquid by the sound waves.

An analyzer according to the present invention is for stirring and reacting different liquids to measure an optical property of a reaction liquid, and thus to analyze the reaction liquid. The analyzer uses the stirrer according to the present invention to optically analyze the reaction liquid containing a specimen and a reagent.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an outline configuration diagram of an automatic analyzer in a first embodiment equipped with a stirrer;

FIG. 2 is a perspective view showing by enlarging an A portion of a cuvette wheel constituting the automatic analyzer shown in FIG. 1, a portion of which is a cross section;

FIG. 3 is a sectional plan view obtained by horizontally cutting the cuvette wheel housing reaction vessels at a position of wheel electrodes;

FIG. 4 is a block diagram showing an outline configuration of the stirrer in the first embodiment together with a sectional view of the reaction vessel;

FIG. 5 is a perspective view of a surface acoustic wave device used in the stirrer in the first embodiment;

FIG. 6 is a waveform chart showing a first example of a drive signal when a drive controller drives the surface acoustic wave device intermittently;

FIG. 7 is a velocity distribution diagram of acoustic flows concerning the distance along a traveling direction of a bulk wave from a point of incidence on a liquid determined for each drive time of the surface acoustic wave device;

FIG. 8 is a waveform chart showing a second example of the drive signal when the drive controller drives the surface acoustic wave device;

FIG. 9 is a waveform chart showing a third example of the drive signal when the drive controller drives the surface acoustic wave device;

FIG. 10 is a velocity distribution diagram of acoustic flows determined in the same manner as in FIG. 7 for a surface acoustic wave device whose transducer has the size of 1 mm;

FIG. 11 is a velocity distribution diagram of acoustic flows determined in the same manner as in FIG. 7 for a surface acoustic wave device whose transducer has the size of 2 mm;

FIG. 12 is a velocity distribution diagram of acoustic flows determined in the same manner as in FIG. 7 for a surface acoustic wave device whose transducer has the size of 2.5 mm;

FIG. 13 is a perspective view corresponding to FIG. 2 of the cuvette wheel of an automatic analyzer according to a second embodiment;

FIG. 14 is a block diagram showing the outline configuration of a stirrer together with a perspective view of a reaction vessel;

FIG. 15 is a frequency response diagram of impedance and phase of a surface acoustic wave device mounted on the reaction vessel shown in FIG. 14.

FIG. 16 is an equivalent circuit diagram of the surface acoustic wave device shown in FIG. 14;

FIG. 17 is an equivalent circuit diagram when the surface acoustic wave device shown in FIG. 14 is driven at a frequency f₁;

FIG. 18 is an equivalent circuit diagram when the surface acoustic wave device shown in FIG. 14 is driven at a frequency f₂;

FIG. 19 is a waveform chart of a drive signal driving the transducer of the surface acoustic wave device at the frequency f₁ while the cuvette wheel is stopped;

FIG. 20 is a sectional view of the reaction vessel showing an acoustic flow arising in a liquid sample in the reaction vessel when the transducer is driven by a drive signal of the frequency f₁ together with a block diagram showing the outline configuration of the stirrer;

FIG. 21 is a waveform chart of the drive signal driving the transducer of the surface acoustic wave device by switching the frequencies f₁ and f₂ while the cuvette wheel is stopped;

FIG. 22 is a sectional view of the reaction vessel showing an acoustic flow generated in the liquid sample in the reaction vessel when the transducer is driven by drive signals of the frequencies f₁ and f₂ being switched together with a block diagram showing the outline configuration of the stirrer;

FIG. 23 is a perspective view corresponding to FIG. 2 of the cuvette wheel of an automatic analyzer according to a third embodiment;

FIG. 24 is a block diagram showing the outline configuration of a stirrer according to the third embodiment together with a perspective view of a reaction vessel;

FIG. 25 is a perspective view of the reaction vessel;

FIG. 26 is a front view of the surface acoustic wave device mounted on an outer surface of a bottom wall of the reaction vessel;

FIG. 27 is a waveform chart of the drive signal driving the transducer of the surface acoustic wave device by switching the frequencies f₁ to f₄ while the cuvette wheel is stopped;

FIG. 28 is a plan view of the reaction vessel showing a sound wave leaked into a liquid sample of the reaction vessel and an acoustic flow caused by the sound wave when the transducer of the surface acoustic wave device is driven by the drive signal at the frequency f₄;

FIG. 29 is a plan view of the reaction vessel showing a sound wave leaked into the liquid sample of the reaction vessel and an acoustic flow caused by the sound wave when the transducer of the surface acoustic wave device is driven by the drive signal at the frequency f₃;

FIG. 30 is a plan view of the reaction vessel showing a sound wave leaked into the liquid sample of the reaction vessel and an acoustic flow caused by the sound wave when the transducer of the surface acoustic wave device is driven by the drive signal at the frequency f₂;

FIG. 31 is a plan view of the reaction vessel showing a sound wave leaked into the liquid sample of the reaction vessel and an acoustic flow caused by the sound wave when the transducer of the surface acoustic wave device is driven by the drive signal at the frequency f₁;

FIG. 32 is a diagram showing a modification of the stirrer in which the surface acoustic wave device is mounted on a sidewall of the reaction vessel together with a block diagram showing the outline configuration of the stirrer and a perspective view of the reaction vessel;

FIG. 33 is a perspective view corresponding to FIG. 2 of the cuvette wheel of an automatic analyzer according to a fourth embodiment;

FIG. 34 is a block diagram showing the outline configuration of a stirrer according to the fourth embodiment together with a perspective view of a reaction vessel;

FIG. 35 is a perspective view of a thickness-extensional vibrator used in the stirrer shown in FIG. 34;

FIG. 36 is a frequency response diagram of the thickness-extensional vibrator showing a relationship between the position of a piezoelectric substrate along a longitudinal direction and a center frequency;

FIG. 37 is a velocity distribution diagram of acoustic flows concerning the distance along the traveling direction of a surface acoustic wave from the point of incidence on a liquid determined for each drive time of the thickness-extensional vibrator;

FIG. 38 is a waveform chart of the drive signal driving the thickness-extensional vibrator at the frequency f₁;

FIG. 39 is a waveform chart of the drive signal driving the thickness-extensional vibrator by alternately switching the frequencies f₁ and f₂; and

FIG. 40 is a block diagram showing the outline configuration of a modification of the stirrer according to the fourth embodiment together with a sectional view of the reaction vessel and a constant temperature bath.

### DETAILED DESCRIPTION OF THE PREFERRED EMBODIMENTS

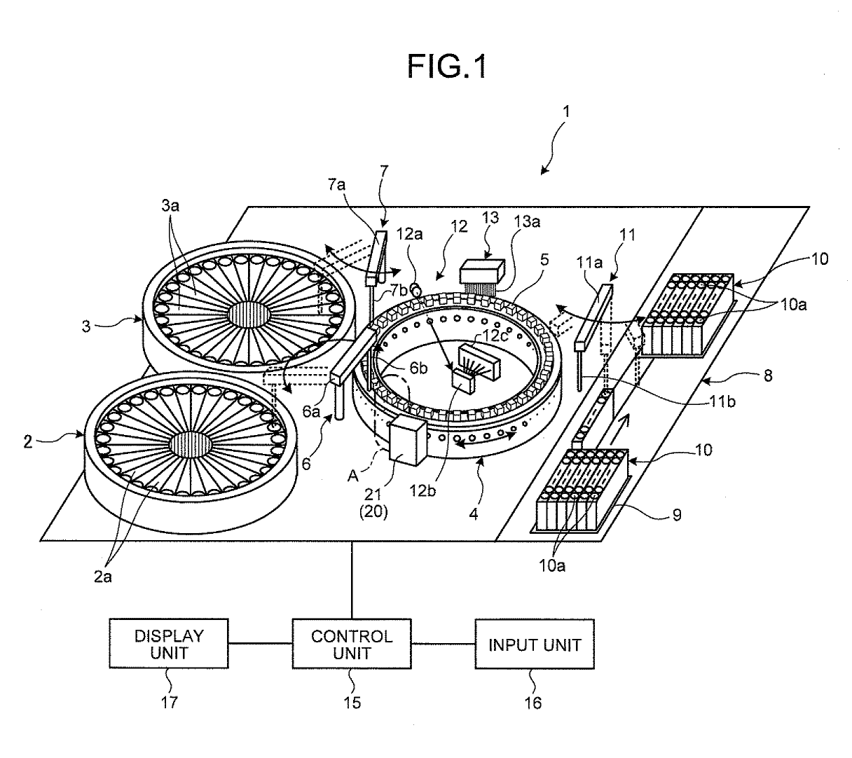

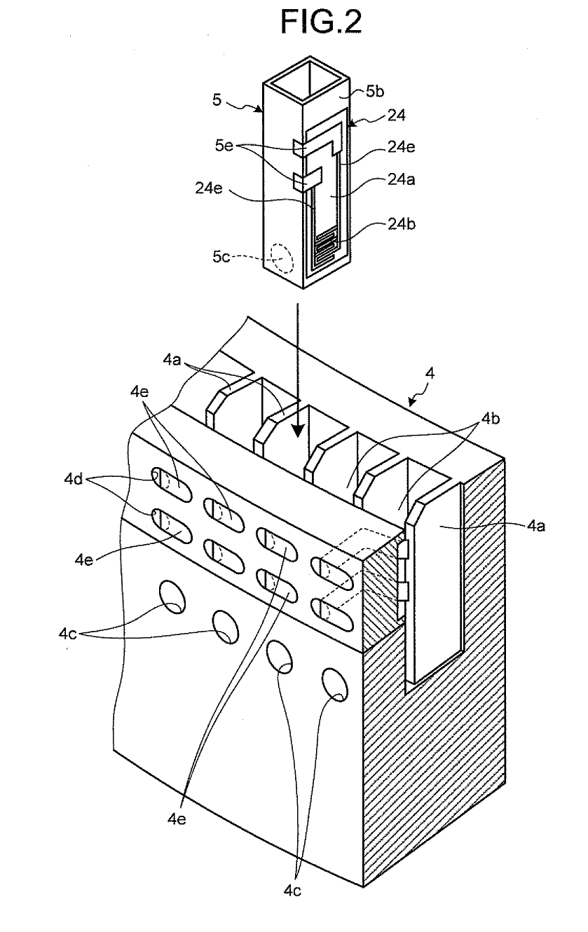

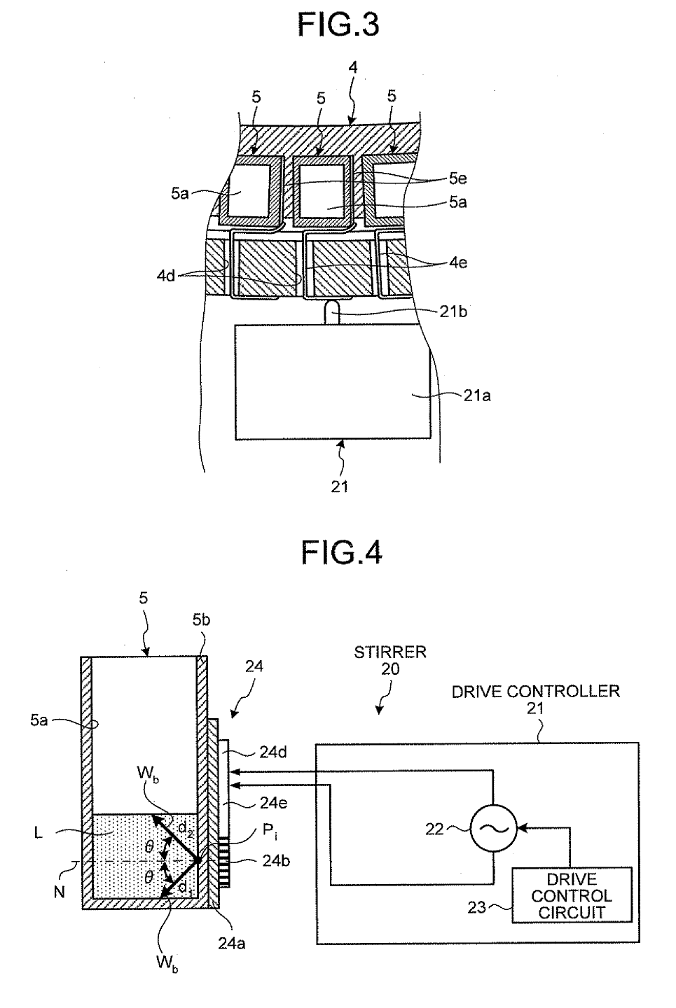

A first embodiment according to a stirrer and an analyzer of the present invention will be described in detail below with reference to drawings. FIG. 1 is an outline configuration diagram of an automatic analyzer in the first embodiment equipped with a stirrer. FIG. 2 is a perspective view showing by enlarging an A portion of a cuvette wheel constituting the automatic analyzer shown in FIG. 1, a portion of which as a cross section. FIG. 3 is a sectional plan view obtained by horizontally cutting the cuvette wheel housing reaction vessels at a position of wheel electrodes. FIG. 4 is a block diagram showing an outline configuration of the stirrer in the first embodiment together with a sectional view of the reaction vessel.

An automatic analyzer 1 has, as shown in FIG. 1 and FIG. 2, reagent tables 2, 3, a cuvette wheel 4, a specimen vessel transport mechanism 8, an analytical optical system 12, a cleaning mechanism 13, a control unit 15, and a stirrer 20.

As shown in FIG. 1, the reagent tables 2, 3 each hold a plurality of reagent vessels 2a, 3a arranged in a circumferential direction and transport the reagent vessels 2a, 3a in the circumferential direction by being rotated by a drive unit.

As shown in FIG. 2, the cuvette wheel 4 has a plurality of holders 4b in which reaction vessels 5 are arranged formed in the circumferential direction by a plurality of partition plates provided along the circumferential direction and transports the reaction vessels 5 in the circumferential direction by being rotated by a drive unit (not shown) in directions indicated by arrows in FIG. 1. As shown in FIG. 2, the cuvette wheel 4 has a photometric hole 4c formed in a radial direction at a corresponding position below each of the holders 4b and wheel electrodes 4e mounted by using each of two upper and lower insertion holes 4d provided above the photometric hole 4c. As shown in FIG. 2 and FIG. 3, one end of the wheel electrode 4e extending from the insertion hole 4d is in contact with the outer surface of the cuvette wheel 4 by being bent and the other end extending from the insertion hole 4d is arranged near an inside surface of the holder 4b by being similarly bent to maintain the reaction vessel 5 arranged inside the holder 4b by spring force. Reagent dispensing mechanisms 6, 7 are provided near the cuvette wheel 4.

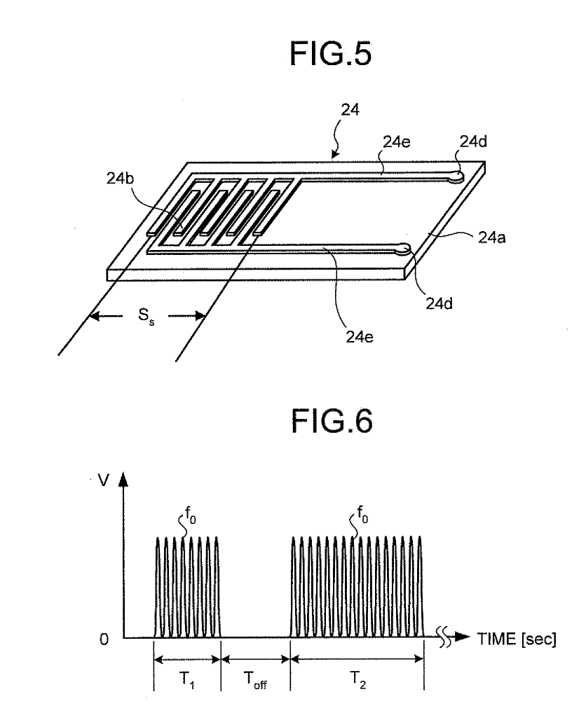

On the other hand, the reaction vessel 5 is formed from an optically transparent material, is a vessel in a rectangular cylindrical shape having a holding unit 5a (See FIG. 4) holding a liquid, as shown in FIG. 2, and has a surface acoustic wave device 24 mounted on a sidewall 5a and also electrode pads 5e mounted to be connected to each of a pair of input terminals 24d of the surface acoustic wave device 24. The reaction vessel 5 uses a transparent material that allows to pass 80% or more of light contained in an analytical beam (340 to 800 nm) emitted from an analytical optical system 12 described later, for example, glass including heat-resistant glass and synthetic resin such as cyclic olefine and polystyrene. A portion of the reaction vessel 5 encircled by a dotted line in a lower part of a sidewall adjacent to a sidewall 5b on which the surface acoustic wave device 24 is mounted is used as a window 5c for measurement allowing the analytical beam to pass through. To use the reaction vessel 5, a drip-proof rubber cap 5d is put on an upper part thereof and the reaction vessel 5 is set to the holder 4b with the surface acoustic wave device 24 directed toward a partition plate 4a. Accordingly, as shown in FIG. 3, each of the electrode pads 5e of the reaction vessel 5 comes into contact with the corresponding wheel electrode 4e. Here, the electrode pad 5e is integrally provided on the input terminal 24d (See FIG. 5) of the surface acoustic wave device 24.

The reagent dispensing mechanisms 6, 7 dispense reagents from the reagent vessels 2a, 3a of the reagent tables 2, 3 to the reaction vessels 5 held in the cuvette wheel 4. As shown in FIG. 1, the reagent dispensing mechanisms 6, 7 have probes 6b, 7b provided for dispensing reagents to arms 6a, 7a rotating in arrow directions on a horizontal plane, have a cleaning unit for cleaning the probes 6b, 7b with washing water respectively, and output a signal about quantities of dispensed reagents to a drive control circuit 23.

As shown in FIG. 1, the specimen vessel transport mechanism 8 is a transport unit for transporting a plurality of racks 10 arranged in a feeder 9 along an arrow direction one by one and transports the rack 10 step by step. The rack 10 holds a plurality of specimen vessels 10a housing specimens. Here, each time the step of the rack 10 transported by the specimen vessel transport mechanism 8 stops, specimens in the specimen vessels 10a are dispensed to each of the reaction vessels 5 by a specimen dispensing mechanism 11 having an arm 11a rotating in a horizontal direction and a probe 41b. Thus, the specimen dispensing mechanism 11 has a cleaning unit for cleaning the probe 11b with washing water. The specimen dispensing mechanism 11 also outputs the signal about quantities of dispensed reagents to the drive control circuit 23.

The analytical optical system 12 emits an analytical beam (340 to 800 nm) for analyzing a liquid sample in the reaction vessel 5 after a reagent and specimen have reacted and has, as shown in FIG. 1, a light emitting unit 12a, a dispersing unit 12b, and a light receiving unit 12c. An analytical beam emitted from the light emitting unit 12a passes through the liquid sample in the reaction vessel 5 before being received by the light receiving unit 12c provided at a position opposite to the dispersing unit 12b. The light receiving unit 12c is connected to the control unit 15.

After discharging the liquid sample in the reaction vessel 5 under suction by a nozzle 13a (See FIG. 1), the cleaning mechanism 13 repeatedly injects and discharges a detergent and a cleaning liquid such as washing water through the nozzle 13a to clean the reaction vessel 5 after analysis by the analytical optical system 12 is completed.

The control unit 15 controls actuation of each part of the automatic analyzer 1 and also analyzes constituent concentrations and the like in a specimen from the rate of absorption of the liquid sample inside the reaction vessel 5 based on the quantity of light emitted by the light emitting unit 12a and that received by the light receiving unit 12c and, for example, a microcomputer is used as control unit 15. As shown in FIG. 1, the control unit 15 is connected to an input unit 16 and a display unit 17. The input unit 16 allows the user to input inspection items and the like into the control unit 15 and, for example, a keyboard or a mouse is used as the input unit 16. The input unit 16 is also used for operations to switch the frequency of a drive signal input into the surface acoustic wave device 24 of the stirrer 20. The display unit 17 displays analysis content, warnings and the like and a display panel or the like is used as the display unit 17.

The stirrer 20 has, as shown in FIG. 4, a drive controller 21 and the surface acoustic wave device 24. The drive controller 21 controls drive conditions of the surface acoustic wave device 24 based on information such as properties of the surface acoustic wave device 24, liquid properties, the shape of the reaction vessel 5, stirring regions desired by the reaction vessel 5 and the like input from the input unit 16 via the control unit 15 in accordance with changes with time of flow caused in the liquid held by the reaction vessel 5 by a sound wave emitted by the surface acoustic wave device 24. The drive controller 21 is arranged on the outer circumference of the cuvette wheel 4 opposite to the cuvette wheel 4 (See FIG. 1) and has, in addition to a brush-like contactor 21b (See FIG. 3) provided in a housing 21a, a signal generator 22 and the drive control circuit 23 in the housing 21a. The contactor 21b is provided in the housing 21a opposite to the two wheel electrodes 4e and comes into contact with the wheel electrode 4e when the cuvette wheel 4 stops so that the drive controller 21 and the surface acoustic wave device 24 of the reaction vessel 5 are electrically connected.

Here, drive conditions of the surface acoustic wave device 24 include, for example, the drive time of the surface acoustic wave device 24, timing of intermittent driving, applied voltage, and drive frequency and the drive controller 21 controls at least one of these conditions. Properties of the surface acoustic wave device 24 include, for example, the size of transducers 24b generating a sound wave, number of the transducers 24b, center frequency and the drive controller 21 controls drive conditions of the surface acoustic wave device 24 in accordance with at least one of these properties. Liquid properties, on the other hand, include, for example, the viscosity, density, surface tension, and liquid level of a liquid and the drive controller 21 controls drive conditions of the surface acoustic wave device 24 in accordance with at least one of these properties.

At this point, as shown in FIG. 4, the liquid level is determined by the drive control circuit 23 from a propagation angle θ of a longitudinal wave mode-converted from a bulk wave W_{b} emitted by the transducer 24b of the surface acoustic wave device 24 with respect to a normal N of the sidewall 5b at a point of incidence Pᵢ where the bulk wave W_{b} enters a liquid L from the sidewall 5b as a longitudinal wave and signals about quantities of dispensed reagents or specimens input by the reagent dispensing mechanisms 6, 7 or the specimen dispensing mechanism 11 when a reagent or a specimen is dispensed to the reaction vessel 5. It is assumed that the distance from the point of incidence Pᵢ to a bottom wall along the traveling direction of the longitudinal wave mode-converted from the bulk wave W_{b} is d₁ and similarly that from the point of incidence Pᵢ to a level is d₂.

The signal generator 22 has an oscillating circuit capable of changing the oscillating frequency based on a control signal input from the drive control circuit 23 and inputs a high-frequency drive signal of several MHz to several hundreds of MHz into the surface acoustic wave device 24. The drive control circuit 23, which uses an electronic control unit (ECU) containing a memory and a timer therefor, controls the voltage and current of a drive signal output by the signal generator 22 to the surface acoustic wave device 24 by controlling actuation of the signal generator 22 based on a control signal input from the input unit 16 via the control unit 15. The drive control circuit 23 controls drive conditions of the surface acoustic wave device 24 and actuation of the signal generator 22. The drive control circuit 23 controls, for example, characteristics (characteristics of the frequency, intensity, phase, and waves) of a sound wave emitted by the surface acoustic wave device 24, waveforms (such as sine waves, triangular waves, rectangular waves, and burst waves), and modulation (amplitude modulation and frequency modulation). The drive control circuit 23 also changes the frequency of a high-frequency signal emitted by the signal generator 22 according to a built-in timer.

The surface acoustic wave device 24 has, as shown in FIG. 5, the transducers 24b as being an interdigital transducer (IDT) arranged at a minimal distance on the surface of a piezoelectric substrate 24a. The transducer 24b is a sound generating element for converting a drive signal input from the drive controller 21 into a bulk wave (sound wave) and a plurality of fingers constituting the transducer 24b is arranged along the longitudinal direction of the piezoelectric substrate 24a. As shown in FIG. 2, the surface acoustic wave device 24 has an edge of the electrode pad 5e put on each of the input terminals 24d so that the drive controller 21 and a pair of the input terminals 24d are connected by the contactor 21b in contact with the wheel electrode 4e. The transducer 24b is connected to the input terminal 24d by a bus bar 24e. The surface acoustic wave device 24 is mounted on the sidewall 5b of the reaction vessel 5 via an acoustic matching layer made of an adhesive such as epoxy resin. Here, the surface acoustic wave device 24 may be constructed so that the surface acoustic wave device 24 is detachably brought into contact with the reaction vessel 5 via an acoustic matching layer such as a liquid and gel when a liquid is irradiated with a sound wave.

Here, the size of the transducer 24b, which is one of the properties of the surface acoustic wave device 24, is a distance Sₛ linking the centers of fingers positioned at both ends among the plurality of fingers constituting the transducer 24b shown in FIG. 5. Drawings showing a surface acoustic wave device described below including the surface acoustic wave device 24 shown in FIG. 5 are mainly intended to show the configuration thereof and thus, the line width or pitch of a plurality of fingers constituting a transducer is not necessarily depicted correctly. In addition to the electrode pad 5e in FIG. 2 being integrally provided on the input terminal 24d, the input terminal 24d itself may be the electrode pad 5e.

In the automatic analyzer 1 configured as described above, the reagent dispensing mechanisms 6, 7 successively dispense reagents to the plurality of reaction vessels 5 being transported along the circumferential direction by the rotating cuvette wheel 4 from the reagent vessels 2a, 3a. Specimens are successively dispensed to the reaction vessels 5 to which reagents have been dispensed by the specimen dispensing mechanism 11 from the plurality of specimen vessels 10a held in the rack 10. Then, each time the cuvette wheel 4 stops, the contactor 21b comes into contact with the wheel electrode 4e to electrically connect the drive controller 21 and the surface acoustic wave device 24 of the reaction vessel 5. Thus, dispensed reagents and specimens in the reaction vessel 5 are successively stirred by the stirrer 20 to react.

The quantity of specimens is usually smaller than that of reagents in the automatic analyzer 1 and thus, a small quantity of specimens dispensed to the reaction vessel 5 is attracted to a large quantity of reagents by a series of flows caused by stirring in the liquid to facilitate a reaction. A reaction mixture as a result of reaction of the specimens and reagents as described above passes through the analytical optical system 12 when the cuvette wheel 4 rotates again and a luminous flux emitted from the light emitting unit 12a is allowed to pass through the reaction mixture. At this point, the reaction mixture of the specimens and reagents in the reaction vessel 5 is measured by the light receiving unit 12c through the luminous flux passed through the reaction mixture and constituent concentrations and the like are analyzed by the control unit 15. Then, after the analysis is completed, the reaction vessel 5 is cleaned by the cleaning mechanism 13 before being reused for analysis of a specimen.

At this point, based on a control signal input from the input unit 16 via the control unit 15 in the automatic analyzer 1 in advance, the drive controller 21 inputs a drive signal from the contactor 21b to the input terminal 24d when the cuvette wheel 4 stops. Accordingly, the transducer 24b of the surface acoustic wave device 24 is driven in accordance with the frequency of the input drive signal to cause a bulk wave (sound wave). The caused bulk wave (sound wave) propagates from the acoustic matching layer into the sidewall 5b of the reaction vessel 5 and, as shown in FIG. 4, the bulk wave W_{b} mode-converted to a longitudinal wave at the interface leaks out into the liquid L having a similar impedance from the point of incidence Pᵢ. As a result, acoustic flows are caused by the longitudinal wave mode-converted from the leaked-out bulk wave W_{b} in the liquid L such as the reagent and specimen held by the reaction vessel 5 and the liquid L is stirred by the acoustic flows.

For this stirring, the drive controller 21 controls drive conditions of the surface acoustic wave device 24 based on information such as properties of the surface acoustic wave device 24, properties of liquid including reagents and specimens to be analyzed, the shape of the reaction vessel 5, stirring regions desired by the reaction vessel 5 and the like input from the input unit 16 via the control unit 15 in accordance with changes with time of flow caused in the liquid held by the reaction vessel 5 by a sound wave emitted by the surface acoustic wave device 24. For example, the drive controller 21 controls timing of intermittent driving, which is a drive condition of the surface acoustic wave device 24, in accordance with the liquid level determined by the drive control circuit 23 and the center frequency of the transducer 24b as a property of the surface acoustic wave device 24 input from the input unit 16. In this case, if the center frequency of the surface acoustic wave device 24 is f₀, as shown in FIG. 6, the drive controller 21 intermittently drives the surface acoustic wave device 24 while the drive control circuit 23 outputs a drive signal of the frequency f₀ from the signal generator 22 through the input terminal 24d to the input terminal 24d by placing the switching time T_{off} (sec) in which no signal irradiation occurs between the drive times T₁ and T₂ (sec) in a time-division fashion.

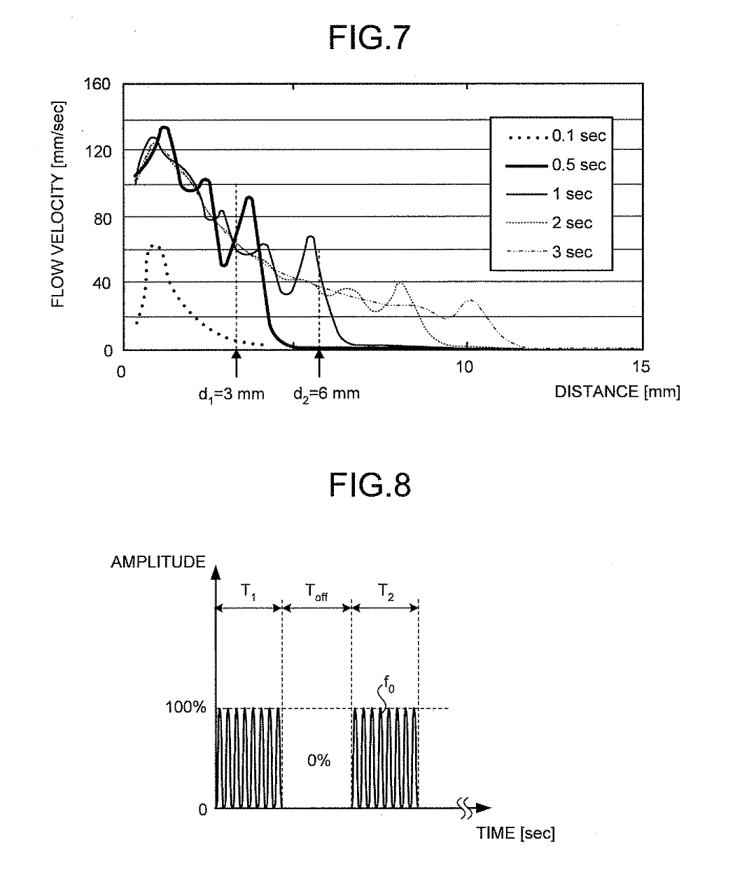

An unsteady acoustic flow is caused in the liquid L held by the reaction vessel 5 by such intermittent driving of the surface acoustic wave device 24 and the dispensed reagent and specimen are stirred. Here, the reaction vessel 5 with length×breadth×height in inside dimensions of 4×4×15 mm and the surface acoustic wave device 24 with the transducer 24b of the size Sₛ=1 mm and the center frequency f₀=81 MHz are used to determine a relationship between the distance along the traveling direction (propagation angle θ=15°) from the point of incidence Pᵢ when the liquid L held by the reaction vessel 5 is stirred and the flow velocity of an acoustic flow. At this point, the surface acoustic wave device 24 is driven for the drive times T₁=T₂=0.1, 0.5, 1, 2, 3 sec with the switching time T_{off}=10 sec. A result thereof is shown in FIG. 7 for each drive time of the surface acoustic wave device 24, taking the distance (mm) along the traveling direction of the bulk wave W_{b} from the point of incidence Pi as the horizontal axis and the flow velocity (mm/sec) of an acoustic flow arising in the liquid L as the vertical axis.

As is evident from the result shown in FIG. 7, acoustic flows for the drive times of 0.1 and 0.5 sec grow while forming an irregular flow field, but an acoustic flow for the drive time of about 1 sec becomes a steady flow in a region relatively close to the point of incidence Pᵢ (See FIG. 4). When a liquid is stirred, an unsteady flow having a transient and fast flow with an unstable flow line can generally be more efficiently stirred than a steady flow with a stable flow line.

Thus, for example, if the distance along the traveling direction of the longitudinal wave mode-converted from the bulk wave W_{b} as the range of desired stirring region is d₁=3 mm and, from the result shown in FIG. 7, the drive time T₁ of the surface acoustic wave device 24 is set to 0.5≦T₁<1 (sec), the flow velocity of acoustic flow will be different even if the distance from the point of incidence Pᵢ is the same, creating a flow field more complex than a steady flow. If, on the other hand, the distance along the traveling direction of the longitudinal wave mode-converted from the bulk wave W_{b} as the range of desired stirring region is d=6 mm, similarly the drive time T₁ of the surface acoustic wave device 24 is preferably set to 1≦T₁<2 (sec). In this case, the switching time T_{off} greatly depends on performance of the drive controller 21, but it is better to set the time as short as possible to form a complex flow field effective for stirring, preferably 100 milliseconds or less.

Therefore, the stirrer 20 can efficiently stir a liquid held by the reaction vessel 5 by causing the drive control circuit 23 in advance to store changes with time of flow caused in the liquid held by the reaction vessel 5 by a sound wave emitted by the surface acoustic wave device 24 and controlling timing of intermittent driving in accordance with the range of desired stirring region while cutting wastes of energy of sound waves by unsteady flows. Moreover, a new component need not be added to components needed for a conventional stirrer to achieve such an excellent effect and therefore, the stirrer 20 is inexpensive and can prevent an automatic analyzer from becoming large.

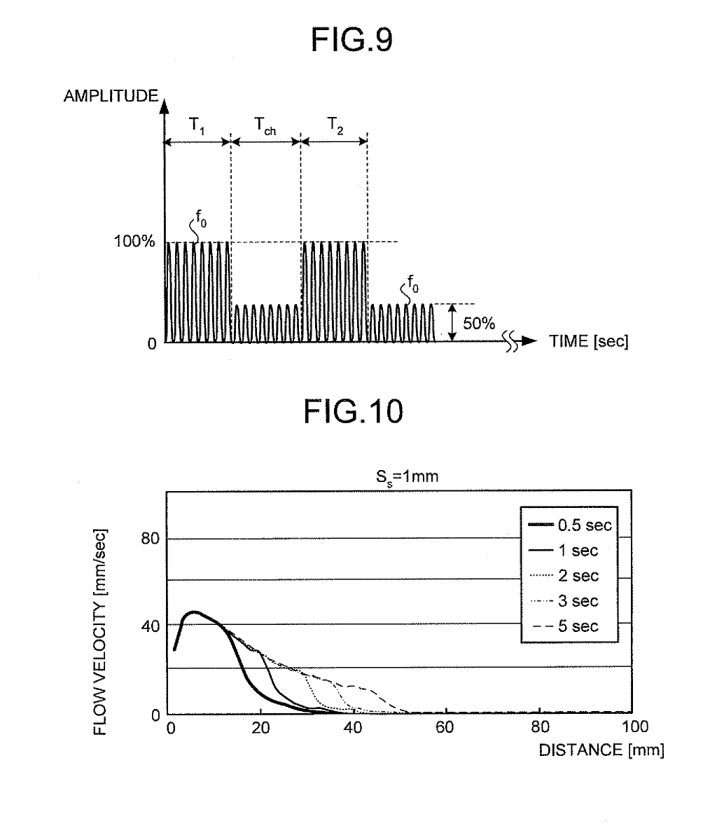

Here, concerning a drive signal of the frequency f₀, the drive controller 21 may drive the surface acoustic wave device 24 intermittently by placing, for example, as shown in FIG. 8, the switching time T_{off} in which the amplitude is 0% between the drive times T₁=T₂ in which the amplitude is 100%. Or, the drive controller 21 may drive the surface acoustic wave device 24 continuously for a predetermined time by placing, as shown in FIG. 9, a switching time T_{ch} in which the amplitude is 50% that in the drive times T₁ and T₂ between the drive times T=T₂ in which the amplitude is 100%. If the surface acoustic wave device 24 is driven under control of amplitude modulation, as described above, the stirrer 20 can reduce energy required for stirring by shortening the drive time of the surface acoustic wave device 24. In this case, the drive controller 21 may drive the surface acoustic wave device 24 by a drive signal having an extremely low amplitude, instead of turning off the drive signal, that is, setting the amplitude to 0%.

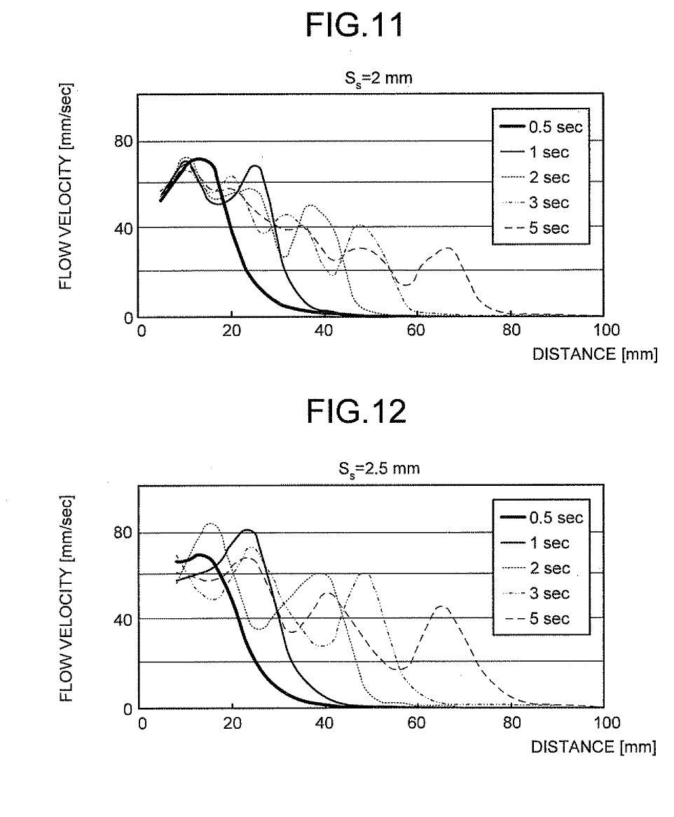

Concerning a velocity distribution diagram of acoustic flows, on the other hand, three types of the surface acoustic wave device 24 with the transducer 24b of the sizes Sₛ=1, 2, 2.5 mm are used to determine velocity distribution in the same manner as FIG. 7 at drive frequency 50 MHz, yielding results shown in FIG. 10 to FIG. 12. These results show that the surface acoustic wave device 24 has different velocity distribution depending on the size of the transducer and the flow velocity of an acoustic flow caused by the increasing size Sₛ of the transducer 24b increases and also the distance reached by the acoustic flow along the traveling direction of the longitudinal wave mode-converted from the bulk wave W_{b} from the point of incidence Pᵢ increases and the range of desired stirring region extends. These results also show that if the range of desired stirring region and the drive time of the surface acoustic wave device 24 are the same, the flow velocity of an acoustic flow increases with the increasing size of the transducer 24b, creating a flow field more complex than a steady flow. Therefore, by controlling drive conditions in accordance with the size of the transducer, a liquid held by the reaction vessel 5 can efficiently be stirred while cutting wastes of energy of sound waves using unsteady flows.

Next, a second embodiment according to a stirrer and an analyzer of the present invention will be described in detail with reference to drawings. In the stirrer and analyzer in the first embodiment, a transducer uses one surface acoustic wave device. In contrast, in the stirrer and analyzer in the second embodiment, a transducer uses two surface acoustic wave devices.

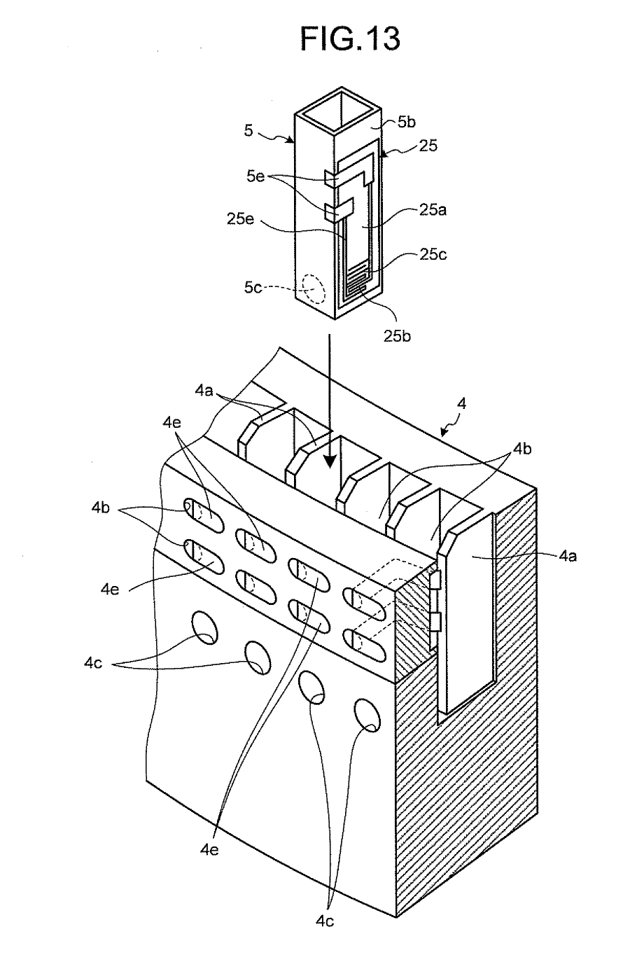

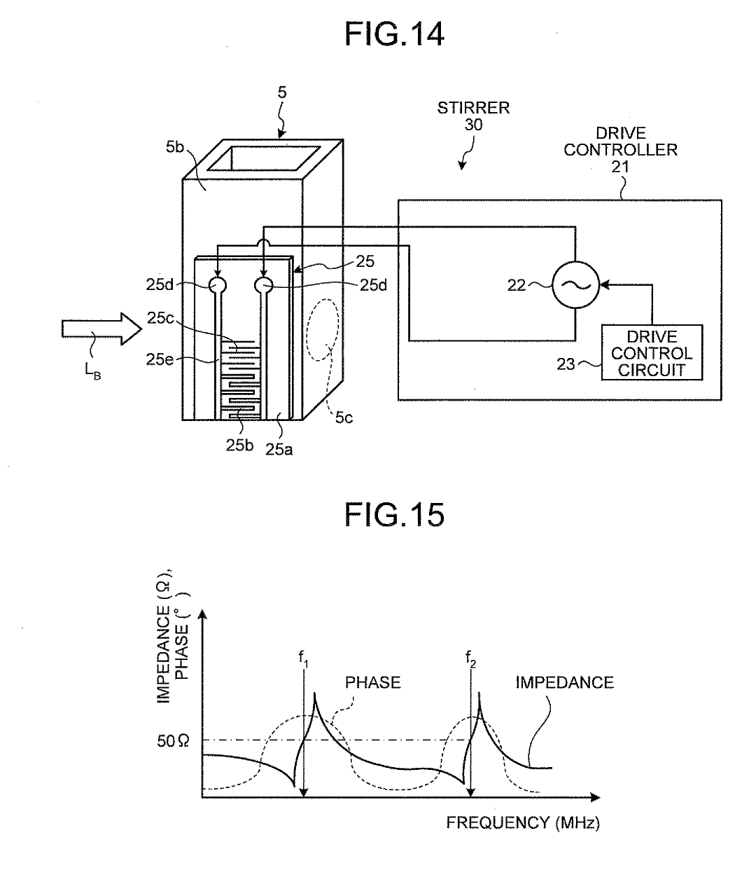

FIG. 13 is a perspective view corresponding to FIG. 2 of the cuvette wheel of an automatic analyzer according to the second embodiment. FIG. 14 is a block diagram showing the outline configuration of the stirrer together with a perspective view of a reaction vessel. If the stirrer and automatic analyzer described below including those in the second embodiment have the same basic components as those in the first embodiment, the same numeral is used for the same component for a description.

As shown in FIG. 13 and FIG. 14, in the automatic analyzer in the second embodiment, a stirrer 30 uses a surface acoustic wave device 25 having two transducers. That is, the surface acoustic wave device 25 of the stirrer 30 has transducers 25b, 25c as being an interdigital transducer (IDT) arranged at a small distance on the surface of a piezoelectric substrate 25a. The transducers 25b, 25c are sound generating elements for converting a drive signal input from the drive controller 21 into a bulk wave (sound wave) and a plurality of fingers constituting the transducers 25b, 25c is arranged along the longitudinal direction of the piezoelectric substrate 25a. A pair of input terminals 25d and the single drive controller 21 are connected by the contactor 21b (See FIG. 3) in contact with the wheel electrode 4e. The transducers 25b, 25c are connected to the input terminal 25d by a bus bar 25e. The surface acoustic wave device 25 is mounted on the sidewall 5b of the reaction vessel 5 via an acoustic matching layer while the pair of input terminals 25d is arranged on the upper side.

It is assumed here that the transducers 25b, 25c each use transducers having frequency characteristics of impedance and phase shown in FIG. 15 with respect to the drive frequency, the center frequency of the transducer 25b is f₁ and that of the transducer 25c is f₂ (>f₁). The surface acoustic wave device 25 is designed so that an electrical impedance at the center frequencies (f₁, f₂) of the transducers 25b, 25c respectively becomes equal to 50Ω of an external electric system and is driven at the center frequencies thereof. Then, an impedance of the transducers 25b, 25c and that of the external electric system match so that the surface acoustic wave device 25 can input a drive signal into the transducers 25b, 25c without electric reflection.

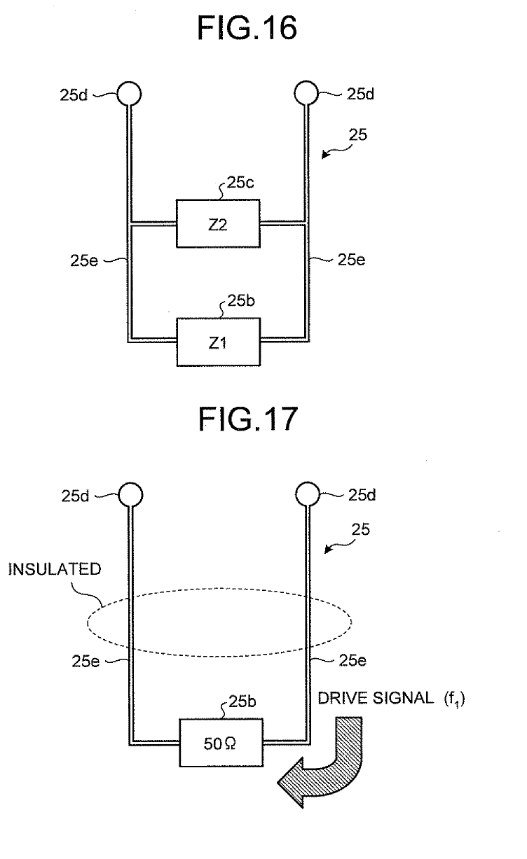

If the impedance of the transducer 25b is Z₁ and that of the transducer 25c is Z₂, an equivalent circuit of the surface acoustic wave device 25 can be represented as in FIG. 16. Thus, if, for example, the drive controller 21 inputs a drive signal of the frequency f₁ into the surface acoustic wave device 25, the impedance of the transducer 25b is 50Ω and that of the transducer 25c goes to infinity. Therefore, the transducer 25c is apparently not present (insulated) in the surface acoustic wave device 25, as shown in FIG. 17, and only the transducer 25b is driven by the input drive signal (f₁).

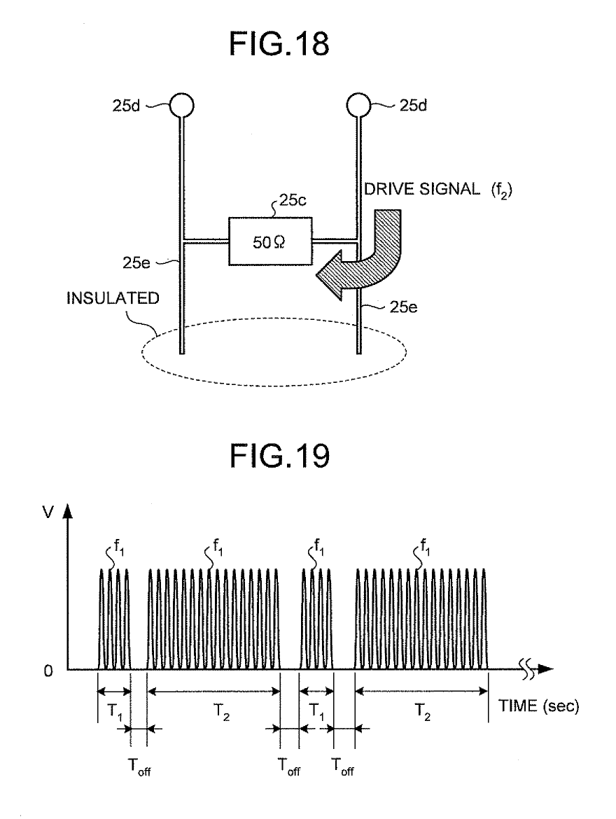

If, on the other hand, the drive controller 21 inputs a drive signal of the frequency f₂ into the surface acoustic wave device 25, the state is reversed in which the impedance of the transducer 25b goes to infinity and that of the transducer 25c is 50Ω. Therefore, the transducer 25b is apparently not present (insulated) in the surface acoustic wave device 25, as shown in FIG. 18, and only the transducer 25c is driven by the input drive signal (f₂). If the impedance of the external electric system takes a different value, for example, 75Ω, the surface acoustic wave device 25 should be designed so that the electrical impedance at the center frequencies of the transducers 25b, 25c will be 75Ω.

Thus, the stirrer 30 switches the drive signal output by the drive control circuit 23 to the surface acoustic wave device 25 based on the quantity of liquid determined from signals about quantities of dispensed reagents and specimens input from the reagent dispensing mechanisms 6, 7 and the specimen dispensing mechanism 11 by causing the drive control circuit 23 in advance to store changes with time of the flow caused in the liquid held by the reaction vessel 5 by a sound wave emitted by the surface acoustic wave device 25. If the quantity of liquid is small, for example, the drive control circuit 23 switches the drive signal to drive the transducer 25b. Accordingly, if the contactor 21b comes into contact with the wheel electrode 4e when the cuvette wheel 4 stops, a drive signal of the frequency f₁ is input from the drive controller 21 into the surface acoustic wave device 25.

Accordingly, as shown in FIG. 19, the transducer 25b of the surface acoustic wave device 25 in the stirrer 30 is intermittently driven by the drive signal of the frequency f1 input in a time-division fashion by placing the switching time T_{off} (sec) in which no signal irradiation occurs between the drive times T₁ and T₂ (sec) while the cuvette wheel 4 is stopped. As a result, a bulk wave (sound wave) caused by the transducer 25b propagates from the acoustic matching layer into the sidewall 5b of the reaction vessel 5 before being leaked out into a liquid sample having a similar acoustic impedance. The leaked-out sound wave causes acoustic flows, which stir dispensed reagents and specimens.

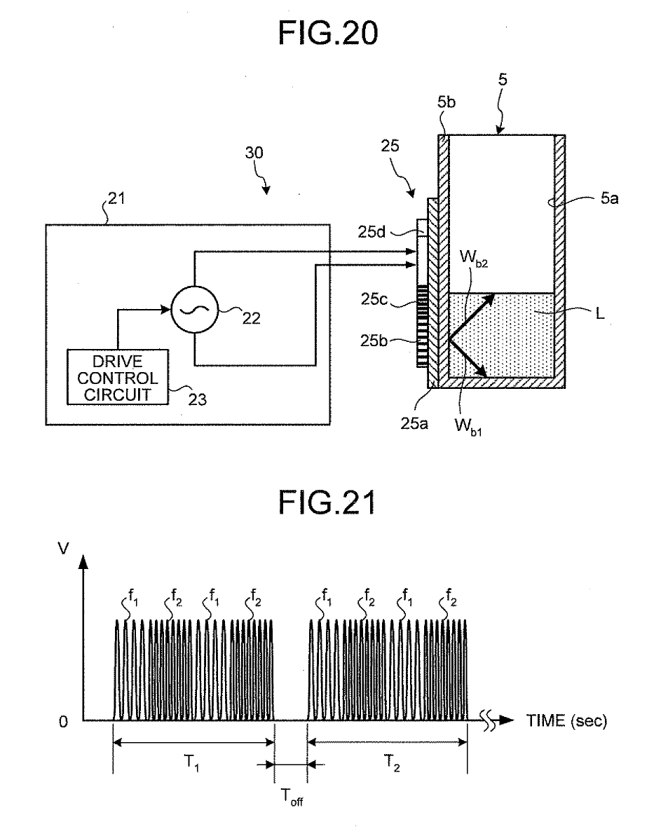

At this point, as shown in FIG. 14, the transducer 25b is arranged below the reaction vessel 5. Thus, as shown in FIG. 20, a sound wave W_{b1} diagonally below from a position in the liquid L corresponding to the transducer 25b as a starting point and a sound wave W_{b2} diagonally above are generated as the longitudinal wave mode-converted from bulk waves leaked into the liquid L of the reaction vessel 5. Therefore, two acoustic flows corresponding to these two directions are generated in the liquid L held in the reaction vessel 5 so that dispensed reagents and specimens can efficiently be stirred while cutting wastes of energy of sound waves.

If, on the other hand, the quantity of liquid is large, for example, the drive control circuit 23 switches the drive signal to drive the transducers 25b and 25c alternately based on the quantity of liquid determined from signals about quantities of dispensed reagents and specimens input from the reagent dispensing mechanisms 6, 7 and the specimen dispensing mechanism 11. Accordingly, as shown in FIG. 21, drive signals of the frequency f₁ and the frequency f₂ are alternately input into the surface acoustic wave device 25 in the stirrer 30 by placing the switching time T_{off} (sec) between the drive times T₁ and T₂ (=T₁) (sec) while the cuvette wheel 4 is stopped. The frequency of the drive signal input by the drive controller 21 into the surface acoustic wave device 25 is thereby changed each time the cuvette wheel 4 stops, self-selectively switching the transducers 25b and 25c for generating a sound wave.

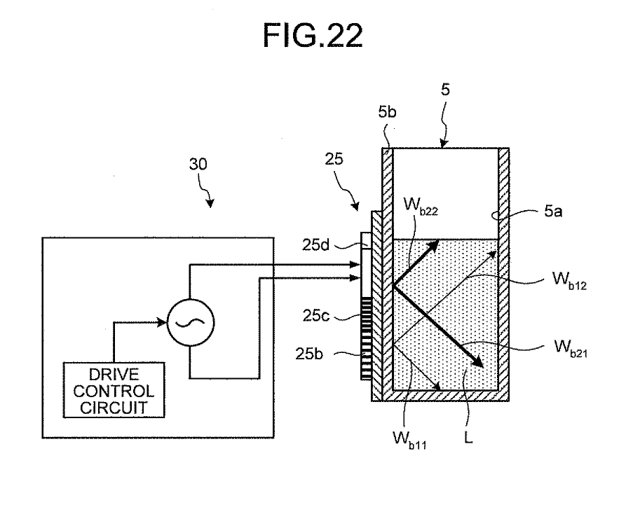

As a result, as shown in FIG. 22, sound waves W_{b11} and W_{b12} of the frequency f₁ from the transducer 25b arranged below and sound waves W_{b21} and W_{b22} of the frequency f₂ from the transducer 25c arranged above leak out alternately into the held liquid L to generate acoustic flows. Thus, the liquid L held by the reaction vessel 5 is efficiently stirred from the bottom to the gas-liquid interface of the reaction vessel 5 while cutting wastes of energy. The switching time of the frequencies f₁ and f₂ needs not be necessarily 1:1 and may be changed when needed in accordance with specimen properties and the like.

At this point, as shown in FIG. 14, regardless of the number of the surface acoustic wave devices 25, the single drive controller 21 and the pair of input terminals 25d are connected by the contactor 21b (See FIG. 3) in contact with the wheel electrode 4e. Moreover, the transducers 25b and 25c for generating a sound wave in the surface acoustic wave devices 25 are self-selectively switched by the frequency being changed by the single drive controller 21. Thus, even if the stirrer 30 has, along with non-necessity of a switch circuit like a conventional stirring unit, the plurality of transducers 25b and 25c having different oscillating frequencies to be sound generating elements, the transducers 25b and 25c that suppress an increase in the number of wires and generate a sound wave with a simple structure can easily be switched to the specific transducer 25b, 25c.

Moreover, the stirrer 30 connects the drive controller 21 and the pair of input terminals 25d by using the surface acoustic wave device 25 having transducers whose oscillating frequency depends on the position and thus, the number of wires can be reduced. Therefore, the stirrer 30 allows the surface acoustic wave devices 25 to be mounted on a small vessel, which enables miniaturization of not only the vessel, but also of the analyzer.

Next, a third embodiment according to a stirrer and an analyzer of the present invention will be described in detail with reference to drawings. The stirrers and analyzers in the first and second embodiments use a surface acoustic wave device in which a plurality of fingers constituting a transducer is all arranged in the same direction. In contrast, the stirrer and analyzer in the third embodiment use a surface acoustic wave device in which orientations of fingers among a plurality of transducers are mutually different by 90 degrees.

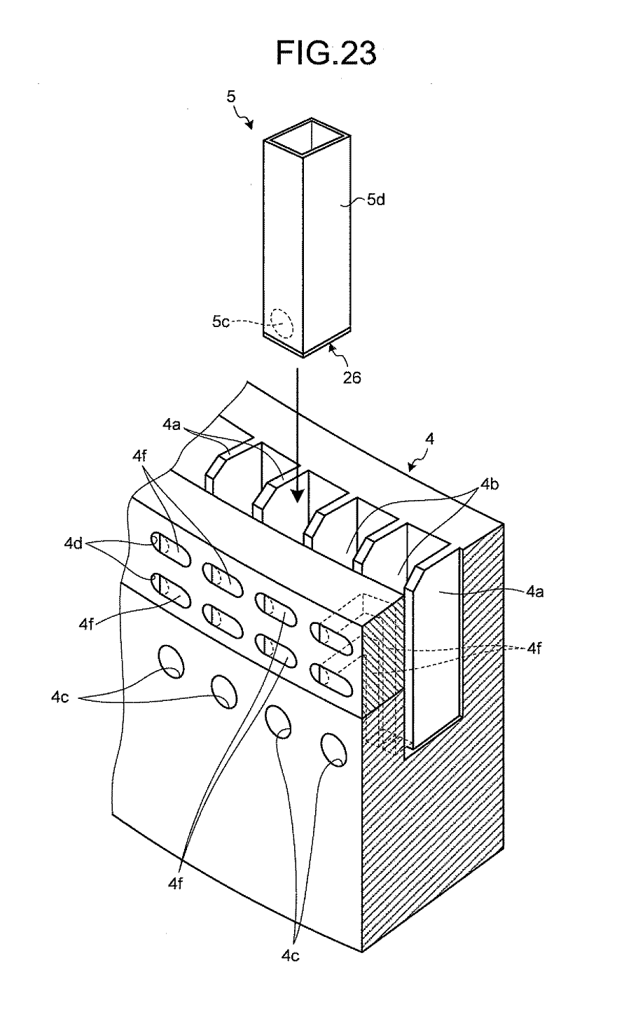

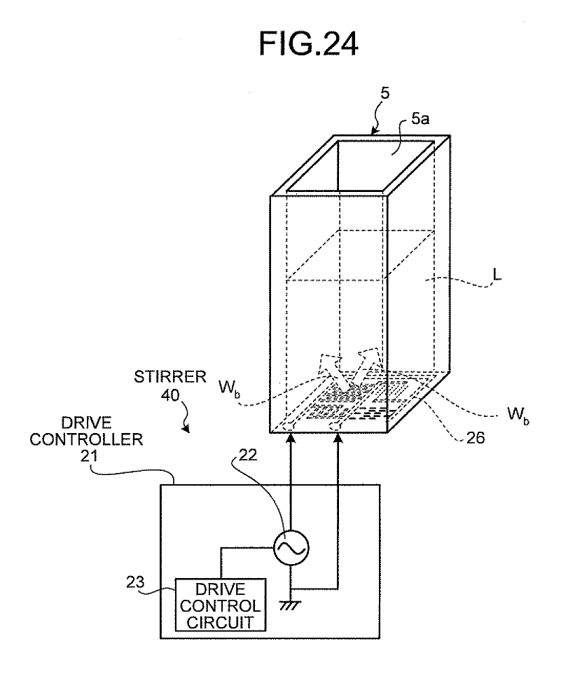

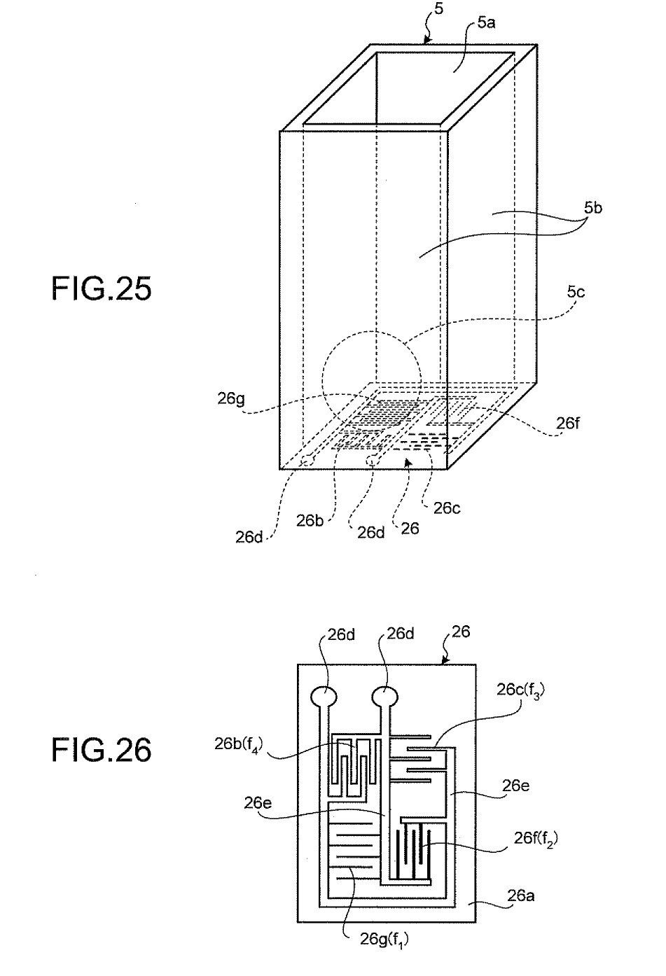

FIG. 23 is a perspective view corresponding to FIG. 2 of the cuvette wheel of an automatic analyzer according to the third embodiment. FIG. 24 is a block diagram showing the outline configuration of a stirrer according to the third embodiment together with a perspective view of a reaction vessel. FIG. 25 is a perspective view of the reaction vessel. FIG. 26 is a front view of the surface acoustic wave device mounted on an outer surface of a bottom wall of the reaction vessel.

As shown in FIG. 23 and FIG. 24, a stirrer 40 in the third embodiment has the drive controller 21 and a surface acoustic wave device 26 mounted on outer surface of the bottom wall of the reaction vessel 5 and when the reaction vessel 5 is housed in the holder 4b of the cuvette wheel 4, a drive signal is input into the surface acoustic wave device 26 from the drive controller 21 via wheel electrodes 4f. Here, the wheel electrodes 4f are different from the wheel electrodes 4e of the stirrers 20, 30 and, as shown in 23, one end of the wheel electrode 4f extending from the insertion hole 4d is in contact with the outer surface of the cuvette wheel 4 by being bent and the other end extending from the insertion hole 4d is in contact with the inside surface of the holder 4b by being similarly bent and then extends downward to be bent at the bottom of the holder 4b along the bottom.

The surface acoustic wave device 26 is mounted on the outer surface of the bottom wall of the reaction vessel 5 via an acoustic matching layer and, as shown in FIG. 26, transducers 26b, 26c (center frequencies f₄, f₃) connected serially by a bus bar 26e and similarly serially connected transducers 26f, 26g (center frequencies f₂, f₁) are connected in parallel to a pair of input terminals 26d. At this point, the orientation of fingers of the transducers 26b, 26f and that of fingers of the transducers 26c, 26g are different by 90 degrees on the plate surface of a piezoelectric substrate 26a. Size relations of the center frequencies f₁ to f₄ are f₁>f₂>f₃>f₄. If, for example, a drive signal of the frequency f₄ is input into the surface acoustic wave device 26, the transducer 26b is excited to generate a bulk wave. A bulk wave generated in this manner propagates through the piezoelectric substrate 26a, the acoustic matching layer, and the bottom wall of the reaction vessel 5 and, as shown in FIG. 24, a longitudinal wave mode-converted from a bulk wave W_{b} is leaked out into the liquid L held by the reaction vessel 5. The leaked-out longitudinal wave mode-converted from the bulk wave W_{b} generates acoustic flows in the liquid L held by the reaction vessel 5 and stirs the liquid L.

The stirrer 40 can efficiently stir a liquid held by the reaction vessel 5 by causing the drive control circuit 23 in advance to store changes with time of flow caused in the liquid held by the reaction vessel 5 by a sound wave emitted by the surface acoustic wave device 26 and causing the drive control circuit 23 to control drive conditions of the surface acoustic wave device 26 while cutting wastes of energy of sound waves by unsteady flows.

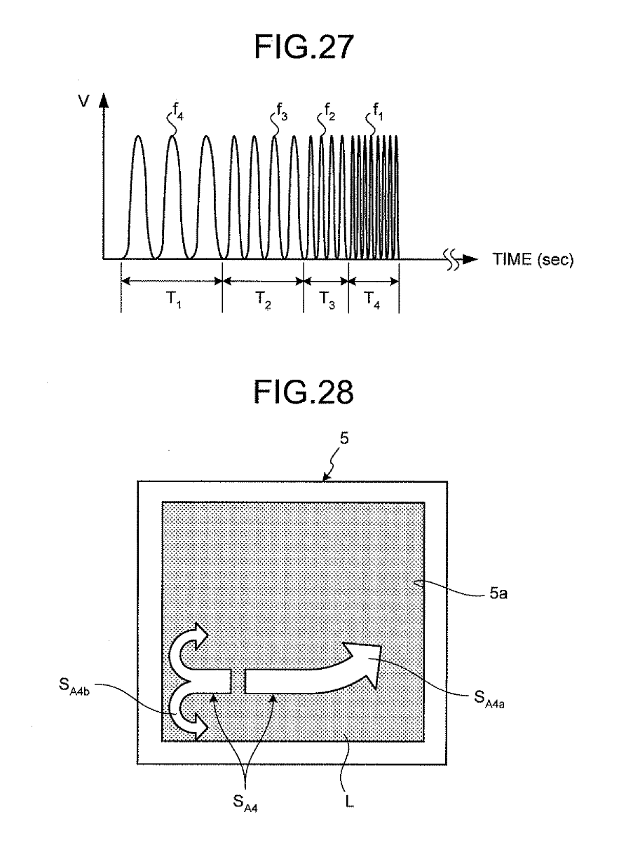

An automatic analyzer in the third embodiment uses the stirrer 40 configured as described above and drive signals of different frequencies are input from the drive control circuit 23 into the surface acoustic wave device 26 by being switched in accordance with changes with time of flow caused in the liquid held by the reaction vessel 5 by sound waves while the cuvette wheel 4 is stopped. That is, as shown in FIG. 27, the drive control circuit 23 inputs drive signals of the frequencies f₄ to f₁ into the surface acoustic wave device 26 by switching in intervals of the drive times T₁ to T₄ (sec). Accordingly, the automatic analyzer can self-selectively switch the transducers 26b, 26c, 26f, and 26g for generating sound waves each time the cuvette wheel 4 stops.

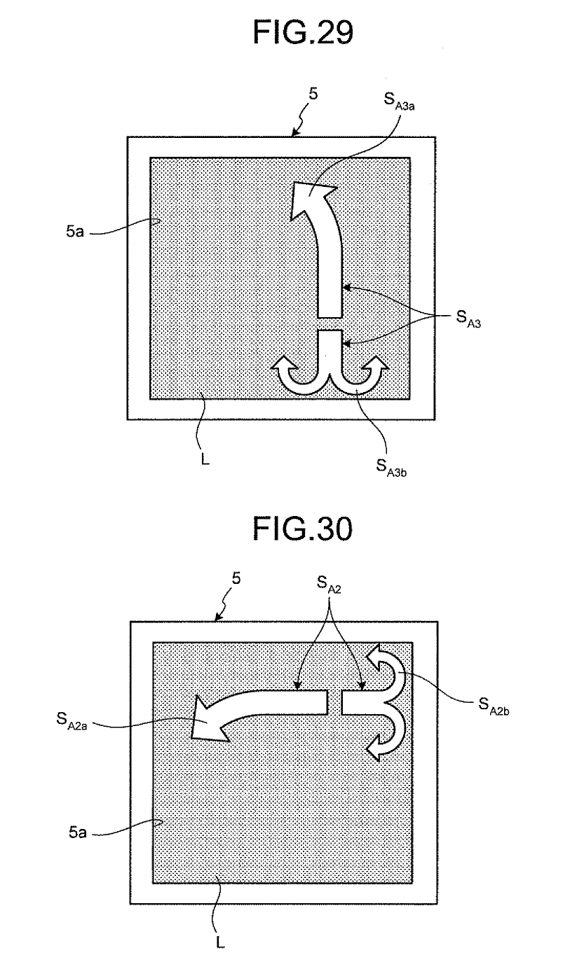

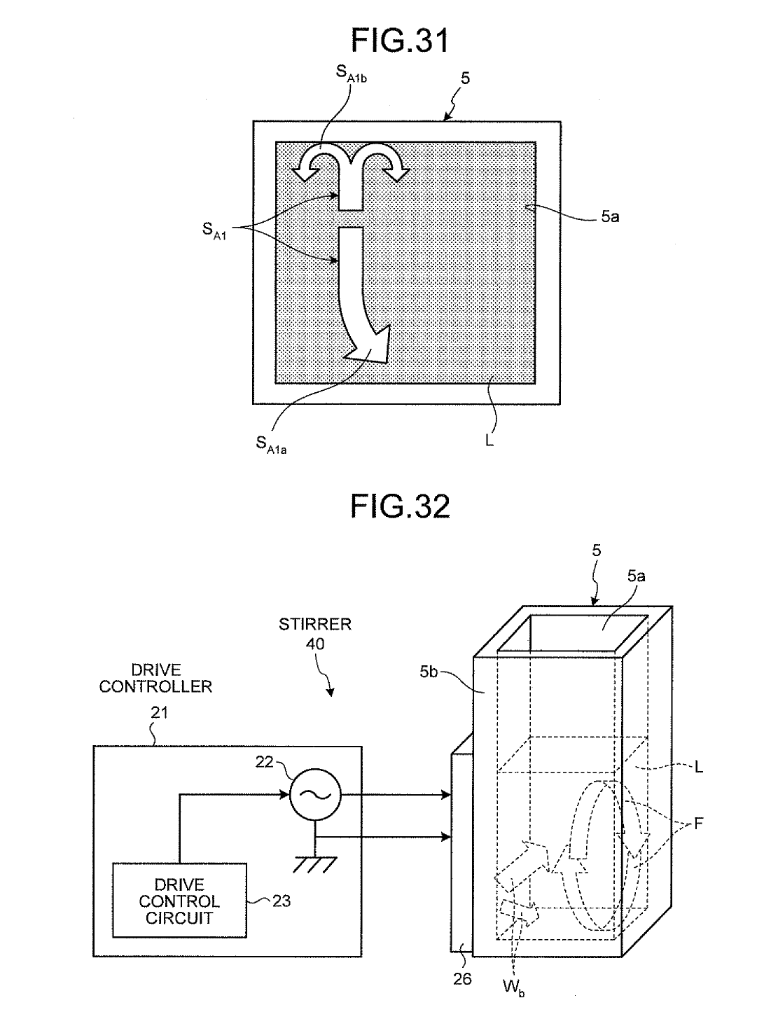

Thus, when the transducer 26b in the stirrer 40 is driven, as shown in FIG. 28, a sound wave of the frequency f₄ leaks out from the bottom wall into the liquid L to generate an acoustic flow S_{A4}. Next, when the transducer 26c in the stirrer 40 is driven, as shown in FIG. 29, a sound wave of the frequency f₃ leaks out from the bottom wall into the liquid L to generate an acoustic flow S_{A3}. Next, when the transducer 26f in the stirrer 40 is driven, as shown in FIG. 30, a sound wave of the frequency f₂ leaks out from the bottom wall into the liquid L to generate an acoustic flow S_{A2}. Then, when the transducer 26g in the stirrer 40 is driven, as shown in FIG. 31, a sound wave of the frequency f₁ leaks out from the bottom wall of the reaction vessel 5 into the liquid L to generate an acoustic flow S_{A1}. Here, for example, the acoustic flow S_{A1} is generated as an acoustic flow S_{A1a} to be a main flow having a high flow velocity and an acoustic flow S_{A1b} directed backward from the acoustic flow S_{A1a} and having a low flow velocity. This also applies to the other acoustic flows S_{A2} to S_{A4}.

As a result, the acoustic flows S_{A4} to S_{A1} successively are generated in the liquid L held by the reaction vessel 5. Among these acoustic flows, the acoustic flows S_{A4a} to S_{A1a} having a high flow velocity lie in a row to form a turning flow in a counterclockwise direction in the liquid L held by the reaction vessel 5. As described above, if the drive control circuit 23 inputs drive signals of different frequencies into the surface acoustic wave device 26 by being switched in accordance with changes with time of flow caused in the liquid held by the reaction vessel 5 by sound waves generated by the surface acoustic wave device 26, a turning flow is generated in the liquid held by the reaction vessel 5.

Thus, the stirrer 40 can stir the liquid L held in the reaction vessel 5 while cutting wastes of energy of sound waves by the turning flow. In this case, the stirrer 40 can stir the liquid L held in the reaction vessel 5 by the transducers 26b, 26c, 26f, and 26g for generating sound waves being switched to a specific transducer by the drive control circuit 23 based on the quantity of liquid held by the reaction vessel 5 determined from signals about quantities of dispensed reagents and specimens input from the reagent dispensing mechanisms 6, 7 and the specimen dispensing mechanism 11 into the drive control circuit 23 while cutting wastes of energy of sound waves.

Here, if the stirrer 40 can stir the liquid L held in the reaction vessel 5 efficiently while cutting wastes of energy of sound waves, the order of switching the frequencies of drive signals driving the surface acoustic wave device 26 by the drive control circuit 23 need not be necessarily the order of f₄, f₃, f₂, and f₁ and arrangement positions of the transducers 26b, 26c, 26f, and 26g are not limited to those shown in FIG. 26. Therefore, after driving the surface acoustic wave device 26 in the order of frequencies f₄, f₃, f₂, and f₁ by the drive control circuit 23, the stirrer 40 may drive the surface acoustic wave device 26 in the order of frequencies f₁, f₂, f₃, and f₄ or any other order. If the order of stirring is reversed as described above, depending on the target to be stirred, directions of acoustic flows caused in the liquid L held in the reaction vessel 5 are thrown into disorder to form a complex flow field so that stirring efficiency of the liquid L can be improved while cutting wastes of energy of sound waves.

As shown in FIG. 32, the surface acoustic wave device 26 having the transducers 26b, 26c, 26f, and 26g in the stirrer 40 may be mounted on the outer surface of the sidewall 5b of the reaction vessel 5. If mounted in this manner, the acoustic flows S_{A4}, S_{A3}, S_{A2}, and S_{A1} arise alternately in the stirrer 40 when drive signals of the frequencies f₄ to f₁ are input by the drive control circuit 23 into the surface acoustic wave device 26 by being switched and a turning flow F caused by longitudinal waves mode-converted from the four types of bulk waves W_{b} leaked from the sidewalls 5b into the liquid L can be made a convection flowing in the vertical direction. Thus, flexibility of design of not only the stirrer 40, but also the automatic analyzer is increased.

Next, a fourth embodiment according to a stirrer and an analyzer of the present invention will be described in detail with reference to drawings. The stirrers and analyzers in the first to third embodiments use a surface acoustic wave device as a sound wave generating device. In contrast, the stirrer and analyzer in the fourth embodiment use a thickness-extensional vibrator.

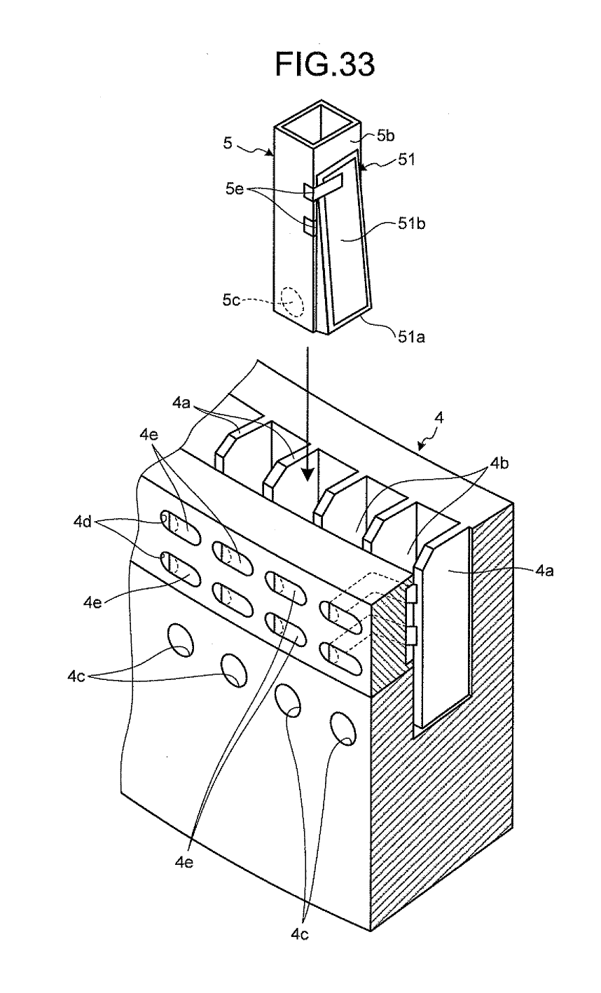

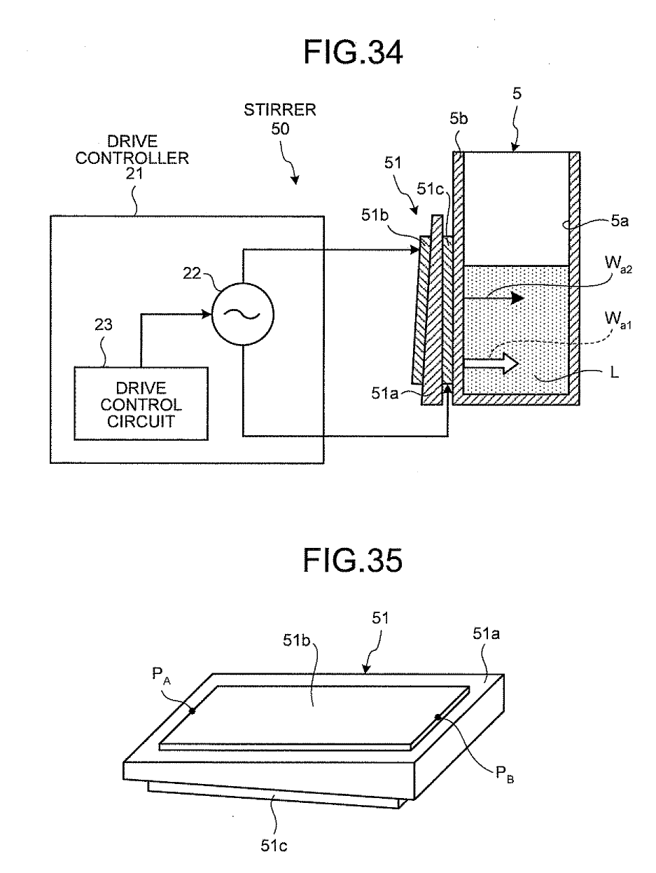

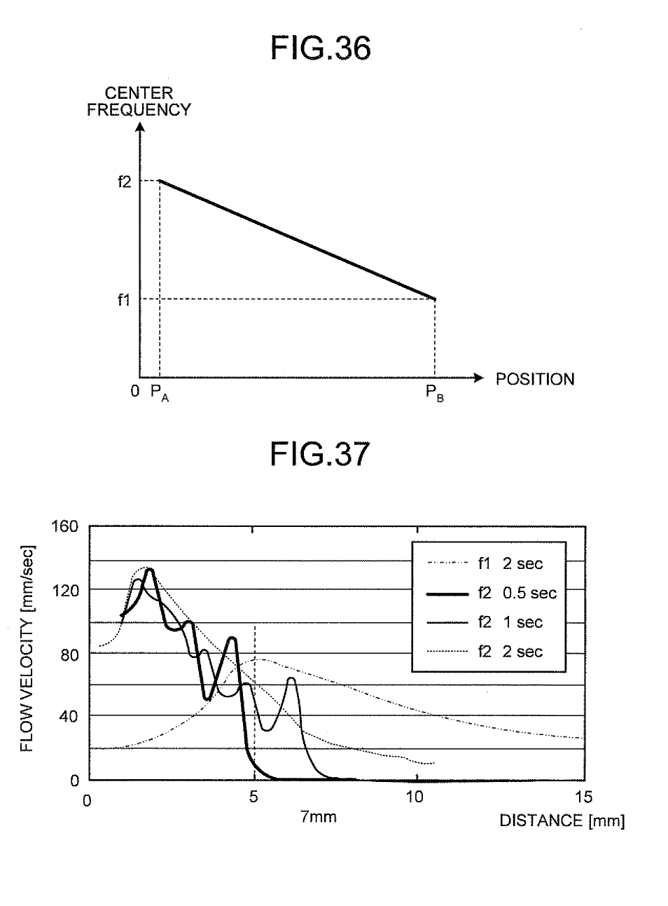

FIG. 33 is a perspective view corresponding to FIG. 2 of the cuvette wheel of an automatic analyzer according to the fourth embodiment. FIG. 34 is a block diagram showing the outline configuration of a stirrer according to the fourth embodiment together with a perspective view of a reaction vessel. FIG. 35 is a perspective view of a thickness-extensional vibrator used in the stirrer shown in FIG. 34. FIG. 36 is a frequency response diagram of the thickness-extensional vibrator showing a relationship between the position of a piezoelectric substrate along a longitudinal direction and a center frequency.

As shown in FIG. 33 and FIG. 34, the automatic analyzer in the fourth embodiment has a stirrer 50 having the drive controller 21 and a thickness-extensional vibrator 51 and the thickness-extensional vibrator 51 is mounted on the outer surface of the sidewall 5b of the reaction vessel 5. Each of the two electrode pads 5e in the reaction vessel 5 is connected to a signal line electrode 51b and a ground electrode 51c of the thickness-extensional vibrator 51 and when the reaction vessel 5 is housed in the holder 4b of the cuvette wheel 4, the electrode pad 5e is connected to the wheel electrode 4e. Therefore, when the contactor 21b comes into contact with the wheel electrode 4e, a drive signal is input from the drive controller 21 into the thickness-extensional vibrator 51.

As shown in FIG. 34 and FIG. 35, the thickness-extensional vibrator 51 has the signal line electrode 51b on one side of a piezoelectric substrate 51a made of lead zirconate titanate (PZT) provided and the ground electrode 51c provided on the other side thereof. The signal line electrode 51b and the ground electrode 51c are sound generating elements for converting power transmitted from the drive controller 21 into a sound wave and a sound wave is emitted from the ground electrode 51c. The piezoelectric substrate 51a is formed in a wedge shape in which one surface on which the signal line electrode 51b is inclined with respect to the other surface on which the ground electrode 51c is provided.

Thus, the thickness-extensional vibrator 51 has a property that in a relationship between the position along the longitudinal direction of the piezoelectric substrate 51a with reference to points P_{A} and P_{B} shown in FIG. 35 and the center frequency, the center frequency linearly decreases as the thickness of the piezoelectric substrate 51a increases. That is, as shown in FIG. 36, the center frequency at the position PA where the thickness-extensional vibrator 51 is the thinnest is f2 and the center frequency decreases as the thickness-extensional vibrator 51 becomes thicker, yielding the center frequency f₁ (<f₂) at the position P_{B} where the thickness-extensional vibrator 51 is the thickest. Therefore, the thickness-extensional vibrator 51 can be considered to be a point-like arrangement of many sound generating elements whose center frequency changes linearly along the longitudinal direction.

Therefore, when a drive signal of different frequencies is input from the drive controller 21 into the thickness-extensional vibrator 51 via the wheel electrode 4e, a sound wave excited by the ground electrode 51c at a position of a thickness of the piezoelectric substrate 51a having the center frequency resonating with the frequency of the input drive signal is emitted and the position of the sound generating element changes along the longitudinal direction.

An automatic analyzer in the fourth embodiment uses the stirrer 50 configured as described above and stirs a liquid held in the reaction vessel 5 efficiently by causing the drive control circuit 23 in advance to store changes with time of flow caused in the liquid held by the reaction vessel 5 by a sound wave emitted by the thickness-extensional vibrator 51 and causing the drive control circuit 23 to control the frequency of drive signals, which is a drive condition of the thickness-extensional vibrator 51, while cutting wastes of energy of sound waves by unsteady flows.

Here, a velocity distribution diagram of acoustic flows is determined in the same manner as in FIG. 7 regarding the stirrer 50 having the thickness-extensional vibrator 51 with the distance between positions P_{A} and P_{B} shown in FIG. 36 of 1 mm, the center frequency at position P_{B} of f₁=50 MHz, and that at position P_{A} of f₂=81 MHz. At this point, the thickness-extensional vibrator 51 is driven by a drive signal of the frequency f₁ for the drive times T₁=T₂=2 sec and the switching time T_{off}=10 sec and that of the frequency f₂ for the drive times T₁=T₂=0.5, 1, 2 sec and the switching time T_{off}=10 sec to determine a relationship between the distance along the traveling direction (propagation angle θ=0°) of a longitudinal wave from the point of incidence and the flow velocity of acoustic flows when a liquid held by the reaction vessel 5 is stirred. A result thereof is shown in FIG. 37 for each drive time of the thickness-extensional vibrator 51, taking the distance (mm) along the traveling direction of the longitudinal wave from the point of incidence as the horizontal axis and the flow velocity (mm/sec) of an acoustic flow arising in the liquid as the vertical axis.

As is evident from the result shown in FIG. 37, an acoustic flow for the drive time 0.5 sec, which is less than 1 sec, grows while forming an irregular flow field, but an acoustic flow for the drive time of about 1 sec becomes a steady flow in a region relatively close to the point of incidence. At this point, the range in which an acoustic flow affects the liquid depends on the size of a sound source and the drive frequency. As described above, the thickness-extensional vibrator 51 can be considered to be a point-like arrangement of many sound generating elements (sound sources) along the longitudinal direction.

Thus, for example, if the range of desired stirring region along the traveling direction of a longitudinal wave Wₐ should be 5 mm, about 2 sec is needed as the drive time T₁ (=T₂) if the thickness-extensional vibrator 51 is driven by the frequency f₁, but if the thickness-extensional vibrator 51 is driven by the frequency f₂, the drive time T₁ (=T₂) satisfying 1 sec≦T₁<2 sec may be selected.

Therefore, the stirrer 50 controls the drive time of the thickness-extensional vibrator 51 in accordance with the range of desired stirring region by causing the drive control circuit 23 in advance to store changes with time of flow caused in the liquid held by the reaction vessel 5 by a sound wave emitted by the thickness-extensional vibrator 51. Accordingly, the stirrer 50 can efficiently stir the liquid held by the reaction vessel 5 while cutting wastes of energy of sound waves by unsteady flows. Moreover, a new component need not be added to components needed for a conventional stirrer to achieve such an excellent effect and therefore, the stirrer 50 is inexpensive and can prevent an automatic analyzer from becoming large.

Here, in the stirrer 50, the frequency of drive signal is changed by the drive control circuit 23 based on the quantity of liquid held by the reaction vessel 5 determined from signals about quantities of dispensed reagents and specimens input from the reagent dispensing mechanisms 6, 7 and the specimen dispensing mechanism 11 into the drive control circuit 23. If the quantity of liquid is small, for example, the drive control circuit 23 inputs a drive signal of the frequency f₁ into the thickness-extensional vibrator 51. Then, in the automatic analyzer, the contactor 21b comes into contact with the wheel electrode 4e when the cuvette wheel 4 stops so that the drive signal of the frequency f₁ is input from the drive control circuit 23 into the thickness-extensional vibrator 51.

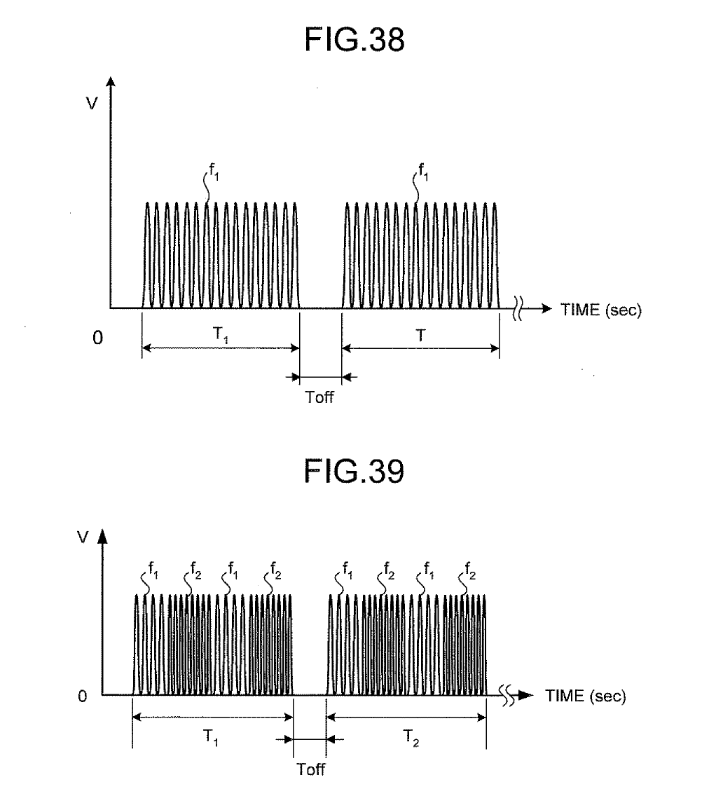

At this point, as shown in FIG. 38, the thickness-extensional vibrator 51 has a drive signal of the frequency f₁ input from the drive control circuit 23 in the drive time T₁ (=T₂) and the switching time T_{off} while the cuvette wheel 4 is stopped. As a result, a surface acoustic wave (sound wave) excited by the thickness-extensional vibrator 51 while the cuvette wheel 4 is stopped propagates from the acoustic matching layer into the sidewall 5b of the reaction vessel 5 and, as shown in FIG. 34, a longitudinal wave Wₐ₁ leaks out into the liquid L having a similar impedance. Thus, acoustic flows are caused by the leaked-out longitudinal wave Wₐ₁ in the liquid held by the reaction vessel 5 and dispensed reagents and specimens are stirred by the acoustic flows.

Here, the position of the thickness-extensional vibrator 51 excited by a drive signal of the frequency f1 is in the lower part of the reaction vessel 5. Thus, as shown in FIG. 34, the sound wave Wa1 leaked into the liquid L propagates in two directions, diagonally above and diagonally below indicated by arrows from the lower part of the reaction vessel 5 corresponding to point P_{B} (See FIG. 35) of the thickness-extensional vibrator 51 as the starting point. Therefore, two acoustic flows corresponding to the two directions arise in the liquid L held by the reaction vessel 5 and dispensed reagents and specimens are stirred by the acoustic flows.

On the other hand, if the quantity of liquid is large, for example, the drive control circuit 23 makes settings so that a drive signal of the frequency f1 and that of the frequency f₂ (>f₁) are alternately input into the thickness-extensional vibrator 51. Accordingly, as shown in FIG. 39, drive signals of the frequency f₁ and the frequency f₂ are alternately input into the thickness-extensional vibrator 51 in the stirrer 50 by placing the switching time T_{off} (sec) between the drive times T₁ and T₂ (=T₁) (sec) while the cuvette wheel 4 is stopped. As a result, the position where a sound wave is generated in the automatic analyzer switches self-selectively between the position corresponding to point P_{A} (See FIG. 35) of the thickness-extensional vibrator 51 and that corresponding to point P_{B} (See FIG. 35) each time the cuvette wheel 4 stops.

Accordingly, as shown in FIG. 34, a sound wave Wₐ₁ of the frequency f₁ and a sound wave Wₐ₂ of the frequency f₂ are alternately leaked out into the liquid L from the ground electrode 51c of the thickness-extensional vibrator 51 in the stirrer 50 to generate an acoustic flow. Therefore, the stirrer 50 generates an effective flow even near the gas-liquid interface so that the liquid L held by the reaction vessel 5 can efficiently be stirred while cutting wastes of energy. Here, the drive control circuit 23 may input any frequency between the frequencies f₁ and f₂ into the thickness-extensional vibrator 51 and may also set the drive times T₁ and T₂ (sec) and the switching time T_{off} (sec) optionally. It is advisable to shorten the switching time T_{off} as much as possible to form a complex flow field needed for stirring.

At this point, as shown in FIG. 34, regardless of the number of the thickness-extensional vibrators 51, the single drive controller 21 and the signal line electrode 51b and the ground electrode 51c, which are a pair of input terminals, are connected by the contactor 21b in contact with the wheel electrode 4e. Moreover, the thickness-extensional vibrator 51 self-selectively switches the position of the sound generating element for generating a sound wave on the ground electrode 51c by changing the frequency of a drive signal by the drive control circuit 23 between the frequencies f₁ and f₂. Thus, even if the stirrer 50 has, along with non-necessity of a switch circuit like a conventional stirring unit, a plurality of sound generating elements having different oscillating frequencies, the stirrer 50 can suppress an increase in the number of wires and switch to a specific sound generating element generating a sound wave with a simple structure.

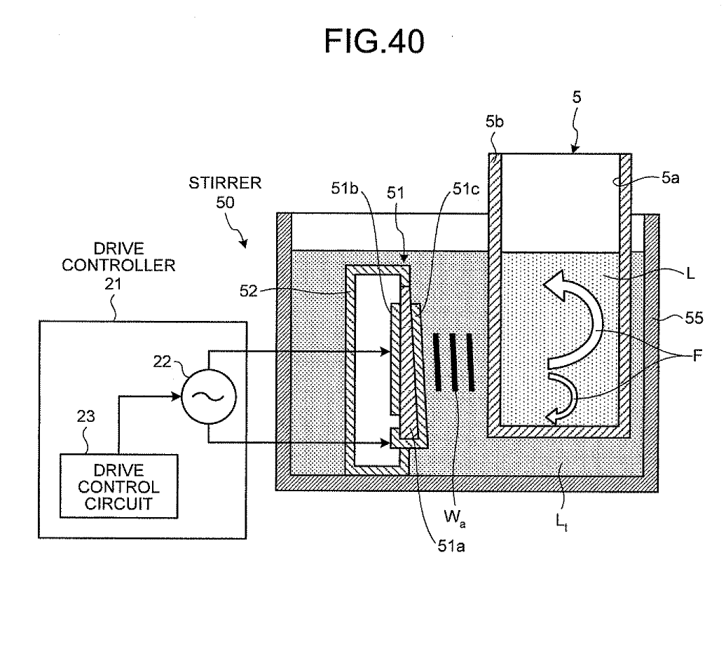

Further, in the stirrer 50 according to the fourth embodiment, as shown in FIG. 40, the reaction vessel 5 and the thickness-extensional vibrators 51 may be separated and arranged in a constant temperature bath 55 in which constant temperature water Lt acting as a acoustic matching layer is housed. Here, compared with the transducer 25b, 25c of the surface acoustic wave device 25, the frequency of the sound wave Wₐ by the thickness-extensional vibrators 51 is lower and thus, attenuation of the sound wave is smaller even if separated from the reaction vessel 5. Therefore, this arrangement is sufficiently usable to generate a flow F in the liquid L. In this case, the thickness-extensional vibrator 51 is mounted on a waterproof case 52 with the signal line electrode 51b directed toward the inside and the ground electrode 51c directed toward the reaction vessel 5.

In each of the above embodiments, the drive controller 21 is provided only at one location, but may be provided at a plurality of locations depending on stirring purposes. Also in each of the above embodiments, the surface acoustic wave devices 24, 25, 26 and the thickness-extensional vibrator 51 as a sound wave generating device are arranged outside the reaction vessel 5 so that the surface acoustic wave device or the thickness-extensional vibrator should not come into contact with a liquid held by the reaction vessel 5. However, the surface acoustic wave device or the thickness-extensional vibrator may be in contact with a liquid constituting a portion of the reaction vessel 5 and held by the reaction vessel 5 as long as the surface acoustic wave devices 24, 25, 26 are connected to the drive controller 21 by a pair of input terminals or the thickness-extensional vibrator 51 is connected to the drive controller 21 by the signal line electrode 51b and the ground electrode 51c, which are a pair of input terminals.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A stirrer for stirring a liquid held in a vessel by sound waves, comprising:
a sound wave generator that generates the sound waves to be applied to the liquid; and
a controller that controls drive conditions for the sound wave generator in accordance with changes with time of flow arising in the liquid by the sound waves.

2. The stirrer according to claim 1, wherein the drive conditions of the sound wave generator include at least one of a drive time of the sound wave generator, timing of intermittent driving, an applied voltage, and a drive frequency.

3. The stirrer according to claim 1, wherein the controller controls the drive conditions of the sound wave generator in accordance with at least one of properties of the sound wave generator, properties of the liquid, a shape of the vessel, and a desired stirring region.

4. The stirrer according to claim 3, wherein the properties of the sound wave generator include at least one of a size of a sound generating element generating the sound wave, a number of sound generating elements, and a center frequency.

5. The stirrer according to claim 3, wherein the properties of the liquid include at least one of viscosity, density, surface tension, and liquid level of the liquid.

6. The stirrer according to claim 1, wherein the sound wave generator is a surface acoustic wave device.

7. The stirrer according to claim 1, wherein the sound wave generator is a thickness-extensional vibrator having a piezoelectric substrate whose thickness increases along one direction and electrodes provided on both sides of the piezoelectric substrate.

8. An analyzer for stirring and reacting different liquids to measure an optical property of a reaction liquid, and thus to analyze the reaction liquid, wherein the analyzer uses a stirrer to optically analyze the reaction liquid containing a specimen and a reagent, the stirrer stirring by sound waves the specimen and the reagent held by a vessel, and including:
a sound wave generator that generates the sound waves to be applied to the specimen and the reagent; and
a controller that controls drive conditions for the sound wave generator in accordance with changes with time of flow arising in the specimen and the reagent by the sound waves.
